(19) United States
(12) Patent Application Publication
(10) Pub. No.: US 2006/0039421 A1
(43) Pub. Date: Feb. 23, 2006

(54) Thermally Tunable Laser with Single Solid Etalon Wavelength Locker

(76) Inventor: Rong Huang, westborough, MA (US)

Correspondence Address: RONG HUANG, 8601 Middleton Circle, Harrisburg, NC, 28075, US

(21) Appl. No.: 10/710,901

(22) Filed: Aug. 11, 2004

(51) Int. Cl. H01S 3/10

(52) U.S. Cl. 372/20

(57) ABSTRACT

A thermally tunable semiconductor laser and a wavelength locker are integrated on one single platform. The temperature of the platform, and the semiconductor, and the wavelength locker is actively adjusted by a thermal electrical cooler. The etalon has a free space range of material dispersion compensated according to the refractive index dependence on the wavelength of the etalon and temperature compensated according to the wavelength dependence of the temperature of the semiconductor laser. The locking point value is adjusted during the operation according to the measured temperature of the etalon.

### BACKGROUND OF INVENTION

1. Field of the Invention

The present invention generally relates to thermally tunable lasers with a wavelength locker of a single solid etalon used in optical communication, optical information processing, optical measurement, and the like.

2. Description of the Related Art

Wavelength stable light sources are key optical components in Wavelength division multiplexing (WDM) systems, in which typically there are multiple separately modulated stable light sources as transmitters packaged in separate packages or a single package. These laser transmitters are designed or actively tuned to operate at different standard wavelengths, usually specified by International Telecommunication Union (ITU) as vₙ=vₒ±n×αv, where vₒ is the central optical frequency 193.1 THz and Δv is the specified frequency channel spacing that may equal a multiple of 100 GHz or 50 GHz. The wavelength stable light sources are generally the distributed feedback laser (DFB) with an active wavelength control device called wavelength locker. The wavelength locker consists of an air-spaced etalon, a multi-phase shifted etalon, a solid etalon with athermal material as its spacing, or a solid etalon sitting on a separate temperature stabilizing device, such as thermal electrical cooler. The DFB lasers have been proven a reliable, cost-effective device used in optical communication.

The wavelength locker is usually an optical device packaged in a separate box or co-packaged in the same box of the laser diode. The co-packaging solution is cost effective and more reliable. The wavelength locker uses an etalon as a wavelength discriminator. The air-spaced etalon is bulky and expensive. It is not compatible with an industry trend toward low-cost, small form-factor, and low power-consumption stabilized laser modules. It is desirable to have an etalon having small size and being co-packaged on the same platform of the laser diode, even though the platform is subject to a larger temperature fluctuation, for example, for thermally tuning distributed feedback laser. This invention reveals how to co-package a wavelength locker with a solid etalon made of readily available material, such as fused silica, on the same platform of the semiconductor laser.

### SUMMARY OF INVENTION

The object of this invention is to provide a way to use a widely available etalon made of materials, such as fused silica, as a wavelength discriminator to lock thermally tunable laser's wavelength, where the etalon is co-packaged on one platform with the laser diode. The laser diode is actively thermally adjusted to change its output wavelength and the etalon is exposed to the same temperature fluctuation. The etalon as a part of wavelength locking scheme stabilizes the output wavelength of the laser diode with electrical controlling circuits.

The free spectrum range of the etalon is tailored according to the wavelength change to temperature of the laser diode to assure an accurate wavelength locking at any pre-set wavelengths.

Another object of the present invention is to provide a process for the wavelength locking using the wavelength locker.

And yet another object of the present invention is to provide for reduced assembly time, reduced cost, and increased quality and the reliability of a device package.

Other objects, advantages, and novel features of the present invention will become apparent from the following detailed description of the invention when considered in conjunction with the accompanying drawings and the following detailed description, in which like reference numerals refer to like parts. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF DRAWINGS

In the accompanying drawings, reference characters refer to the same parts through the different views. The drawings are not necessarily to scale; emphasis has instead been placed upon illustrating the principles of the invention. Of the drawings:

FIG. 1 shows one layout of a laser diode with an etalon co-packaged on one platform which sits on a thermal adjustor (not shown), such as thermal electrical cooler.

FIG. 2 illustrates transmission spectra of an etalon with 100 GHz free spectrum range at temperatures.

FIG. 3 shows transmission spectra of an etalon with compensated free spectrum range at different temperatures.

FIG. 4 shows an etalon design to lock to channels with the spacing of about the half of the FSR of the etalon and the locking point compensated to the temperature change.

FIG. 5 illustrates a locking process of adjusting the initial locking point value.

### DETAILED DESCRIPTION

Distributed feedback semiconductor lasers or distributed Bragg reflection semiconductor lasers are a key device and widely deployed in optical communication. their wavelength can be thermally tuned for a few 100 GHz. To meet the strict requirement of the wavelength stability, their wavelength is controlled by a wavelength locker, in which usually a Fabry-Perot etalon is used as a wavelength discriminator.

The etalon in a wavelength locker usually has 100 GHz free spectrum range, which is equal to the most popular ITU-defined channel spacing. When it is used to lock a thermally tunable laser, the temperature dependence of the FSR of the etalon becomes a concern. If a solid etalon is made of, e.g., fused silica, the etalon is placed on a separate temperature controller from the laser diode; other-wise, an air-spaced etalon is used to counter the temperature fluctuation. Either ways increase packaging complicacy and the cost. The laser diode and etalon co-packaged on one platform is preferred.

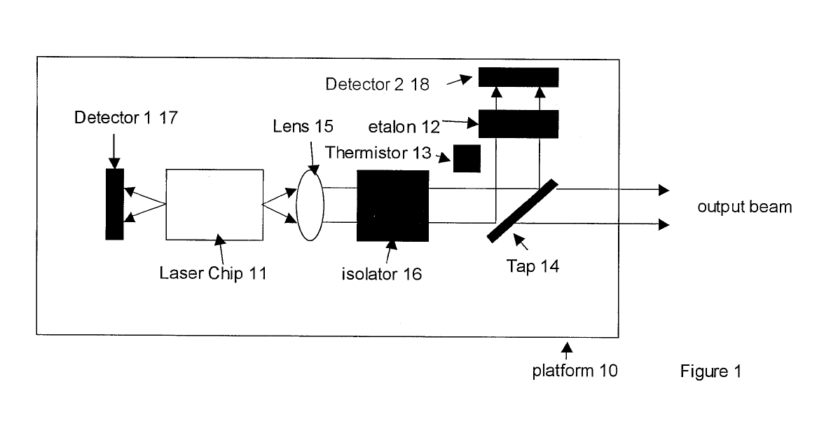

One of wavelength locker and laser diode arrangements is shown in the FIG. 1 for example. The wavelength locker and the laser diode are packaged on single platform, which is made of a highly thermally conductive material, such as AIN and Kovar. There are various ways to layout the laser diode and the wavelength locker on the platform as described in prior arts. The output wavelength from the laser diode is adjusted by changing the temperature of the laser diode, for example, by sitting the platform on a thermal electrical cooler. The detector 117 sits behinds the laser diode to monitor the power output. The output beam is collimated from its front side, and passes through a isolator 17. A tap 14 sits an angle in the path of the beam to deviate a small portion of the beam towards the etalon, which sits intentionally perpendicular to the incoming optical beam. The second detector 18 is set behind the etalon to record the wavelength-dependent intensity. The ratio of the signal from the detector 218 to the detector 117 tells the output wavelength of the laser diode. Comparing to a pre-calibrated ratio (for a channel wavelength at a calibration temperature T), the diode is set to the channel wavelength.

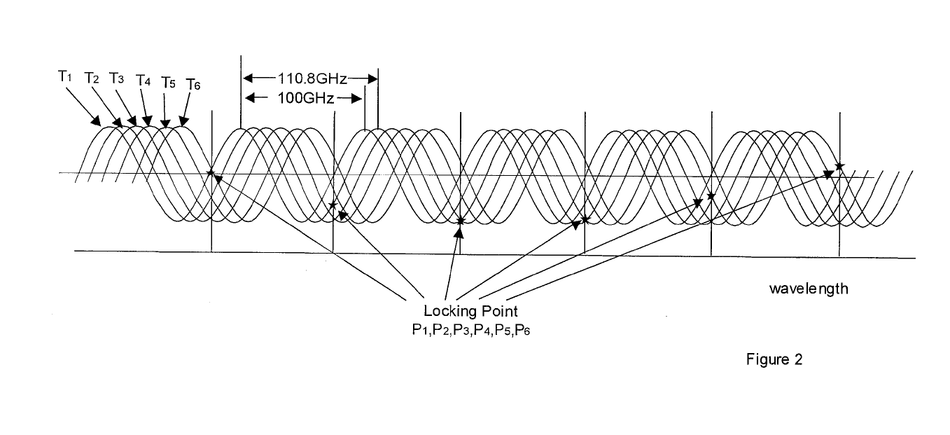

If the temperature of the platform changes, the transmission fringes of the etalon shift. As shown in FIG. 2, the transmission fringes of an etalon with FSR 100 GHz shift left further and further with the increase of the temperature for such as fused silica etalon. For example, at the temperature T₁, T₂, T₃, T₄, T₅, T₆, the output wavelengths from the laser diode are channel 1, 2, 3, 4, 5 and 6 and the locking points on the flanks of the transmission fringes are P₁, P₂, P₃, P₄, P₅, and P₆, respectively. Initially, at the temperature T₁, the locking point P₁ is set at the middle of one flank of the transmission fringes with a maximum slope which allows the most accurate wave-length locking subject to a given intensity detection accuracy. The locking points P₂, P₃, P₄, P₅, and P₆ are around the middle of their respective flank. However, at the temperature T₂, the locking point P₂ slips down the flank, as shown in the FIG. 2. At the temperature T₃ and T₄, the locking points slip further to the valley of the transmission fringes, where the slopes approach to zero and the locking accuracy is very poor. At the temperature T₅ and T₆, the locking points P₅ and P₆ move to the flank of negative slope. The locking points scatter along the fringes, when the temperature changes.

To maintain the locking points around the maximum slope of the flanks for a few channels at different temperatures, the temperature effect should be taken into account. The free spectrum range of the etalon should not be set at 100 GHz or other ITU channel spacing. For a laser diode, Its temperature dependence of emission wavelength (dλ/dT)ₗₐₛₑᵣ can be easily measured. The temperature dependence of the transmission peak of the etalon (dλ/dT)ₑₜₐₗₒₙ can be measured, too, which is caused by the temperature dependence of its refractive index and physical thickness (its wavelength dependence is ignored in a small wavelength range). (dλ/dT)ₑₜₐₗₒₙ=λ(1/n(λ, T)dn(λ, T)/dT+1/t(T)dt(T)/dT), where n(λ, T) is the refractive index of the material of etalon and t(T) is the thickness of the etalon. The temperature change to drive the wavelength of the laser diode from one channel to another is ΔT=Δλ/(dλ/dT)ₗₐₛₑᵣ, where Δλ is the channel spacing, e.g., 100 GHz (here using 100 GHz for Δλ than ˜0.8 nm at the wavelength of λ is for the convenience of description, same elsewhere). The free spectrum range of the etalon should be set at FSRₑₜₐₗₒₙ=Δλ−(dλ/dT)ₑₜₐₗₒₙ×ΔT; in other words, the FSR plus the peak shift of the etalon during ΔT is equal to the channel spacing Δλ. For example, for 100 GHz channel spacing, (dλ/dT)ₗₐₛₑᵣ=12.5 GHz/° C. for the laser diode, (dλ/dT)ₑₜₐₗₒₙ=1.35 GHz/° C. for fused silica etalon, the free space range of the desired etalon is equal to 100 GHz-100 GHz/12.5×1.35=89.2 GHz. From this FSR, the thickness of the etalon can be derived. The etalon should be selected to have a much smaller temperature dependence (dλ/dT)ₑₜₐₗₒₙ than the (dλ/dT)ₗₐₛₑᵣ. The smaller (dλ/dT)ₑₜₐₗₒₙ allows the locked laser diode to maintain long term stability subject to possible temperature fluctuation, especially, when the actual temperature of the etalon is a little different from the measured temperature. The widely used material for etalon is fused silica. The material for etalon should be transparent at the interested wavelength and has long term chemical stability and robust mechanical properties such as related to polishing, such as laser host material LiCaAlF₆, sapphire.

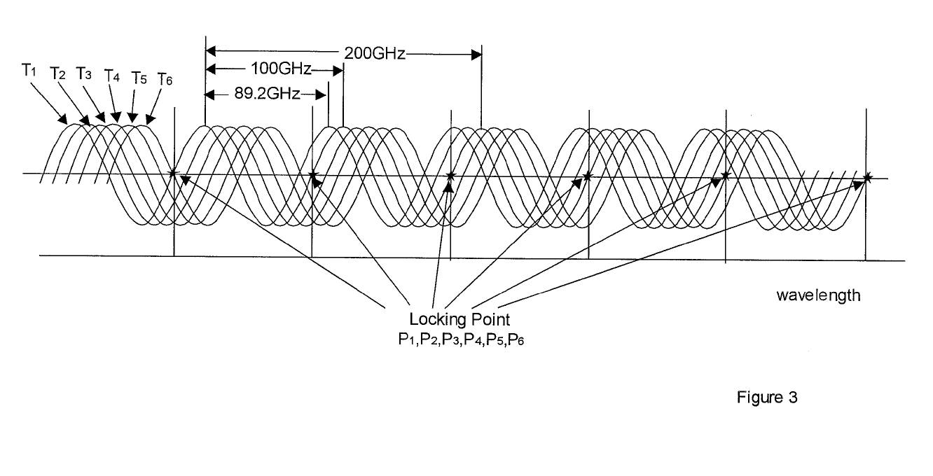

Shown in FIG. 3, using the above example of the etalon with a free space range 89.2 GHz, the initial locking point is set at the middle of one flank of a transmission fringe at temperature T₁ for channel 1. When the temperature increases from T₁ to T₂, the emission wavelength of the semiconductor laser increases by 100 GHz and the fringes of the etalon shifts left 10.8 GHz. In addition to the free spacing range of 89.2 GHZ, the second channel's locking point P₂ sits on the middle of the flank of the next fringe. And equally for P₃, P₄, P₅, P₆ of channel 3, 4, 5, 6 at temperature T₃, T₄, T₅, T₆. The locking points for all these channels are set at the middle of the flanks of the transmission fringes to ensure an accurate wavelength locking.

The above gives the operating principle of the present invention. If we know the temperature and wavelength dependence of the refractive index and the thermal expansion coefficient of the material of the etalon, the detailed design of the etalon can start from the formula of the etalon transmission intensity as a function of temperature and wavelength I(T, λ)=1/[1+4R/(1−R)²sin²(2πn(λ, T)ₜ(T)cos(θ)/λ], where R is the reflectivity of the etalon, n(λ, T) is the refractive index at wavelength λ and temperature T, t(T) is the physical thickness of the etalon at temperature T, and θ is the refraction angle in the etalon and is assumed to be zero degree here. At temperature T₁ and the peak wavelength λ₁, the resonance condition 2n(λ₁, T₁)t(T₁)=mλ₁; at the temperature T₂ and the peak wavelength λ₂, the resonance condition 2n(λ₂, T₂)t(T₂)=(m−L)λ₂, where m and L (order difference between the two peaks) are integers. L can be chosen to be 1, 2, . . . to let λ₂−λ₁ cover about the middle half of the tuning range of the laser diode. The etalon physical thickness at the temperature T₁, t(T₁)=[Lλ₁λ₂+2n(λ₂, T₂)αΔTλ₁]/[2n(λ₁, T₁)λ₂−2n(λ₂, T₂)λ₁], where α is the thermal expansion coefficient of the etalon. The calculated thickness t(T₁) is corrected for the material dispersion to its linear term (the refractive index is a function of wavelength and can be written as n₀+a(λ−λ₀)+higher order terms around λ₀, where n₀ is a refractive index at the wavelength λ₀ and the second term is the linear term and a is a constant) and the temperature effect on the etalon. Assuming λ₁=1550.116 nm, λ₂=1550.918 nm, T₁=22° C., T₂=30° C., for fused silica etalon α=0.52×10⁻⁶/° C., n(λ₁, T₁)=1.443985, n(λ₂, T₂)=1.4440512, the t(T₁)=1.139 mm. In most case, the temperature and wavelength dependence of the refractive index and the thermal expansion coefficient are not accurately known, a few times try-and-error should be taken to find the thickness of the etalon.

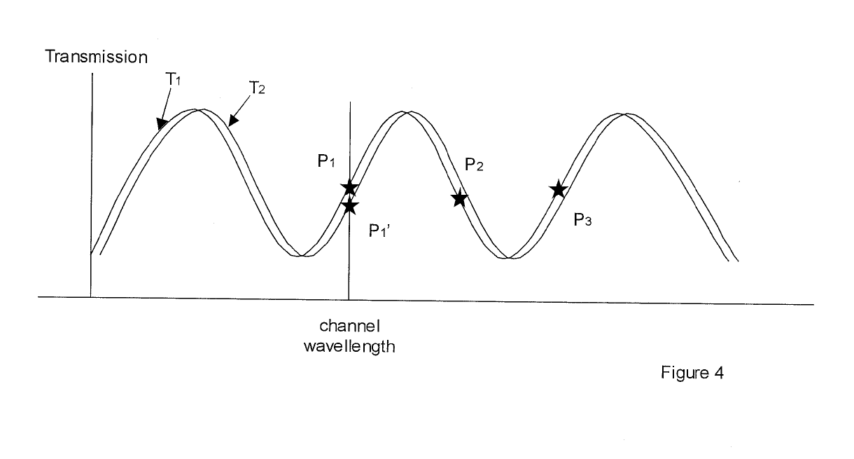

FIG. 4 shows using the flanks of the etalon transmission fringes with both positive and negative slope to lock wavelengths. For a thermally tunable laser, the locking points for every channel are calibrated before its deployment. The output (channel) wavelength after calibration is affected by the device aging and by the injection current change to control the output power. Usually this wavelength deviation from its calibrated value is small. Chung et al, experimentally showed that the emission wavelength ages less than 0.1 nm for most DFB lasers in “Aging-Induced Wavelength Shifts in 1.5 μm DFB laser”, IEEE Photon. Tech. Lett., vol. 6, 1994. 0.1 nm wavelength aging corresponds to ˜1° C. temperature adjustment needed for DFB lasers. For this 1° C. temperature change, the fused silica etalon fringe shifts about 1.35 GHz. It results in the wavelength locking error 1.35 GHz. If this error is beyond the tolerance, the locking point value should be adjusted according to the temperature change. As shown in FIG. 4, an illustration, the locking point value should be adjusted to P₁′ when the temperature changes from T₁ to T₂. The adjustment P₁P₁′ is calculated according to the transmission intensity formula by an amount of (I(λ, T₂)−I(λ, T₁)), where λ is the locked wavelength. If we know the slope dI(λ, T)/dλ at the locking point, P₁P₁′ is also equal to the slope multiplied by the wavelength shift.

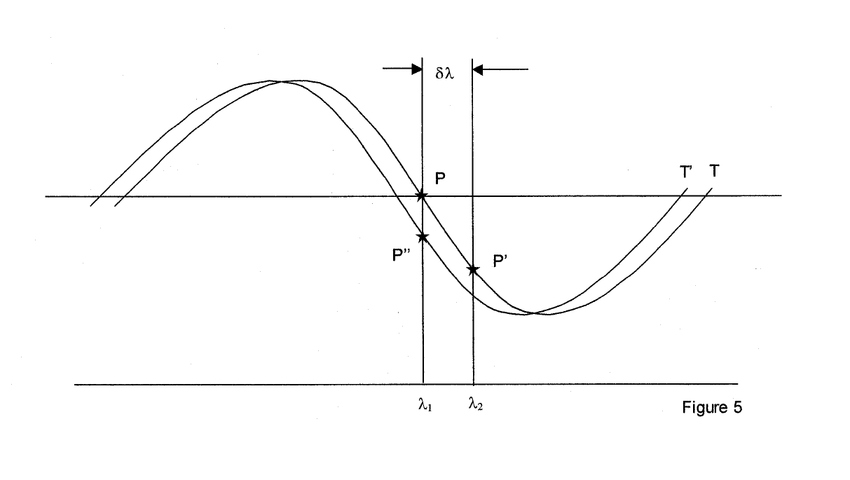

FIG. 5 illustrates a process for locking a wavelength. It is assumed that at the temperature T, the pre-calibrated locking ratio is P at the channel wavelength λ₁. During the operation, when setting the temperature to T, the measured locking ratio, say, is P′ different from the pre-calibrated P. The reason for the discrepancy may come from the device aging. The temperature should be reduced to T′ to decrease the output wavelength from the laser diode. At T′, the locking ratio should be adjusted to P″ according to above method. The temperature adjustment process may go a few times until the measured locking ratio matching the adjusted locking ratio.

The locking process is completed by an outside electronic circuit board. The board has the functions of calculating the ratio between two detectors, comparing the ratio to a pre-calibrated locking point value, adjusting the temperature, adjusting the pre-calibrated locking point value according to the measured temperature. A locking cycle is as follow: (a) to set the temperature of the platform to a temperature at which the pre-calibrated locking point value was taken, (b) calculated the locking ratio, (c) comparing the calculated locking ratio to the pre-calibrated locking point value, (d) if there is a discrepancy, to adjust the temperature to match the calculated ratio to the pre-calibrated locking point value, (e) to adjust the pre-calibrated locking point value according to the measured temperature (a new pre-calibrated locking point value), (f) to repeat (c) to (e) until the calculated ratio matching the adjusted pre-calibrated locking point value.

While the invention has been shown and described with reference to one specific preferred embodiment, it should be understood by those skilled in the art that various changes in form and detail may be made therein without departing from the spirit and scope of the invention as defined by the following claims.

1. A wavelength locked thermally tunable laser comprising:
A semiconductor laser, whose output wavelength adjusted thermally and continuously;
A wavelength locker, comprising:
(a) a solid etalon, whose free space range or its physical thickness relates to the temperature characteristics of said semiconductor laser;
(b) a first photo detector for detecting a collimated light extracted from said semiconductor laser and transmitting through said solid etalon;
(c) a second photo detector for detecting the power output of said semiconductor laser;
Said semiconductor laser and wavelength locker packaged on one single platform;
The temperature of said platform, semiconductor laser and solid etalon adjusted by a thermal electrical cooler;
A temperature detecting element disposed near said solid etalon for detecting the ambient temperature of said etalon;
A means of locking the wavelength of said semiconductor laser to a specific wavelength by an outside electronic controller.

2. A wavelength locked thermally tunable laser of claim 1 wherein said solid etalon having a free spectrum range FSR or physical thickness t(T) at a temperature T is defined by a first partial reflector and a second partial reflector, said reflectors formed on the two parallel surfaces of a piece of transparent material.

3. The solid etalon of claim 2 wherein the FSR of said solid etalon
$$FSR = Δ v - \frac{Δ v}{{( \frac{ⅆ v}{ⅆ T} )}_{laser}} \times {( \frac{ⅆ v}{ⅆ T} )}_{etalon} ,$$
where Δv is the channel spacing, such as 100 GHz, 50 GHz etc.; (dv/dT)ₗₐₛₑᵣ the temperature dependence of the emission frequency of said semiconductor laser; and (dv/dT)ₑₜₐₗₒₙ the temperature dependence of said solid etalon's resonance peak frequency.

4. The solid etalon of claim 2 wherein the physical thickness t(T) of said solid etalon
$$t ( {T}_{1} ) = \frac{L {λ}_{1} {λ}_{2} + 2 n ( {λ}_{2} , {T}_{2} ) αΔ T {λ}_{1}}{2 n ( {λ}_{1} , {T}_{1} ) {λ}_{2} - 2 n ( {λ}_{2} , {T}_{2} ) {λ}_{1}} ,$$
where λ₁ is the output wavelength at temperature T₁ of said semiconductor laser; Δλ is the channel spacing corresponding to 100 Ghz, 50 GHz, etc.; λ₂=λ₁+LΔλ is the output wavelength at T₂ of said semiconductor laser; α is the thermal expansion coefficient of the material of said solid etalon; L is an integer(=1, 2, . . . ); ΔT=T₂−T₁ is the temperature change required to change the output wavelength from λ₁ to λ₂ of said semiconductor laser; n(λ₁, T₁) and n(λ₂, T₂) are the refractive index of the material of said solid etalon at λ₁, T₁ and λ₂, T₂, respectively.

5. The wavelength locked thermally tunable laser of claim 1, further comprising a means to adjust a locking point value set at temperature T and wavelength λ according to a measured temperature T′ by an amount of [I(λ, T′)−I(λ, T)], where I(λ, T) is the normalized (against the power fluctuation) transmission intensity of said solid etalon at the locking wavelength λ and the temperature T and I(λ, T′) is the normalized transmission intensity of said solid etalon at the locking wavelength λ and temperature T′.
